(19) United States
(12) Patent Application Publication
(10) Pub. No.: US 2014/0313565 A1
(43) Pub. Date: Oct. 23, 2014

(54) ELECTRONIC PAPER AND METHOD OF DISPLAYING IMAGE ON THE SAME

(71) Applicant: Samsung Display Co., Ltd., Yongin-City (KR)

(72) Inventors: Byoung Kul Ji, Suwon-si (KR); Chang Hun Lee, Suwon-si (KR)

(73) Assignee: Samsung Display Co., Ltd., Yongin-City (KR)

(21) Appl. No.: 13/972,829

(22) Filed: Aug. 21, 2013

(30) Foreign Application Priority Data
Apr. 17, 2013 (KR) 10-2013-0042377

(51) Int. Cl. G02F 1/167

(52) U.S. Cl. CPC G02F 1/167
USPC 359/296

(57) ABSTRACT

An electronic paper including an image control layer, the image control layer including a magnetic material and capable of forming a magnetic pattern therein, the electronic paper further including an image display layer on the image control layer, the image display layer including a plurality of image display units having magnetic properties.

### CROSS-REFERENCE TO RELATED APPLICATION

This application claims priority to and the benefit of Korean Patent Application No. 10-2013-0042377, filed on Apr. 17, 2013, in the Korean Intellectual Property Office, the disclosure of which is incorporated herein by reference in its entirety.

### BACKGROUND

1. Field

The present invention relates to electronic paper and a method of displaying an image on the same.

2. Description of the Related Art

Electronic paper is becoming widely utilized as a medium for displaying images. Compared with comparable displays, electronic paper may be used to display images with a relatively low frame conversion rate. Electronic paper may be used in a wide variety of applications including electronic books, electronic newspapers, electronic wallpaper, and electronic photo frames. However, applications of electronic paper are not limited to these examples.

Methods of realizing electronic paper include a liquid crystal method, an electroluminescence method, a reflective film reflective display method, an electrophoresis method, a twist ball method, an electrochromic method, and a mechanical reflective display method. Electronic paper realized using these methods consumes power to display and maintain an image. For example, twist ball-type electronic paper uses twist balls, which take on an electric charge and have different colors in different portions thereof, as devices for displaying an image. The twist ball-type electronic paper controls the rotation of the twist balls by applying an electric field to the twist balls, thereby controlling an image that is displayed.

When electronic paper is used in electronic wallpaper or electronic photo frames, it often has to display an image for a long period of time. Accordingly, it is desirable to reduce the power consumption of the electronic paper. Even when the electronic paper is used in applications other than electronic wallpaper and electronic photo frames, the power consumption of the electronic paper is desired to be reduced to increase the operation time of the electronic paper.

### SUMMARY

Aspects of the embodiments according to the present invention are directed to an electronic paper with reduced power consumption.

Aspects of the embodiments according to the present invention are also directed to a method of displaying an image on electronic paper with reduced power consumption.

However, aspects of the embodiments according to the present invention are not restricted to the ones set forth herein. The above and other aspects of the present invention will become more apparent to one of ordinary skill in the art, to which the present invention pertains, by referencing the detailed description of embodiments according to the present invention provided below.

According to an aspect of embodiments of the present invention, there is provided an electronic paper including: an image control layer including a magnetic material and capable of forming a magnetic pattern therein and an image display layer on the image control layer, the image display layer including a plurality of image display units having magnetic properties.

The electronic paper may further include a magnetic pattern forming layer under the image control layer, the magnetic pattern forming layer including a plurality of magnetic pattern forming units, each of the magnetic pattern forming units being configured to generate a magnetic field having a direction that can be controlled.

Each of the magnetic pattern forming units may include an electromagnet.

The electromagnet may include a core and a coil around the core, the electronic paper further including a magnetic pattern control unit configured to control the direction of an electric current flowing through the coil according to image data.

Each of the image display units may include a first region and a second region having different colors, wherein magnetic poles located in the first region and the second region are different from each other.

The image display units may have a spherical shape.

The image display layer may include: a first substrate; a second substrate on the first substrate; and a barrier structure between the first substrate and the second substrate and having a plurality of openings, wherein each of the image display units is located in a corresponding one of the openings.

The first substrate and the second substrate may include a nonmagnetic material.

The image display layer may include: a first substrate; and a second substrate on the first substrate, wherein the image display units are between the first substrate and the second substrate, and the first substrate includes alignment portions protruding upward from a top surface of the first substrate, the alignment portions being located between the image display units.

The electronic paper may further include a lubricating fluid between the first substrate and the second substrate.

A magnetic field of the image control layer in which the magnetic pattern is formed may be greater than a magnetic field of each of the image display units.

According to another aspect of the embodiments of the present invention, there is provided a method of displaying an image on an electronic paper, the method including: preparing the electronic paper including an image control layer including a magnetic material, and an image display layer including a plurality of image display units having magnetic properties, the image display layer being on the image control layer; placing the electronic paper on a magnetic pattern forming apparatus including a plurality of magnetic pattern forming units, each of the magnetic pattern forming units being configured to generate a magnetic field having a direction that can be controlled; and forming a magnetic pattern in the image control layer by controlling the direction of the magnetic field of each of the magnetic pattern forming units.

Each of the magnetic pattern forming units may include an electromagnet including a core and a coil around the core, and the controlling of the direction of the magnetic field of each of the magnetic pattern forming units may include controlling the direction of an electric current flowing through the coil of each of the magnetic pattern forming units.

Each of the image display units may include a first region and a second region having different colors, wherein magnetic poles located in the first region and the second region are different from each other.

The image display layer may include: a first substrate; a second substrate on the first substrate; and a barrier structure between the first substrate and the second substrate and having a plurality of openings, wherein each of the image display units is located in a corresponding one of the openings.

The forming of the magnetic pattern may include moving the magnetic pattern forming units while varying the direction of the magnetic field of each of the magnetic pattern forming units.

The image display layer may include: a first substrate; and a second substrate on the first substrate, wherein the image display units are between the first substrate and the second substrate, and the first substrate includes alignment portions protruding upward from a top surface of the first substrate, the alignment portions being located between the image display units.

According to another aspect of the embodiments of the present invention, there is provided a method of displaying an image on an electronic paper, the method including: preparing the electronic paper including an image control layer including a magnetic material, and an image display layer, including a plurality of image display units having magnetic properties, the image display layer being on the image control layer; and forming a magnetic pattern in the image control layer by moving a magnetism generating apparatus having a pole of a magnet disposed at an end thereof on the electronic paper.

The method may further include initializing the electronic paper by forming a magnetic pattern in the image control layer such that magnetic fields of at least some regions of the image control layer have the same direction.

The image display layer may include: a first substrate; and a second substrate on the first substrate, wherein the image display units are between the first substrate and the second substrate, and the first substrate includes alignment portions protruding upward from a top surface of the first substrate, the alignment portions being located between the image display units.

### BRIEF DESCRIPTION OF THE DRAWINGS

The above and other aspects and features of the present invention will become more apparent by describing in detail example embodiments thereof with reference to the attached drawings, in which:

FIG. 1 is a cross-sectional schematic view of an electronic paper, according to an example embodiment of the present invention;

FIG. 2 is a flowchart illustrating a method of displaying an image on an electronic paper, according to an example embodiment of the present invention;

FIG. 3 is a cross-sectional schematic view of electronic paper in one step of a process of preparing the electronic paper, according to an example embodiment of the present invention;

FIG. 4 is a cross-sectional schematic view of the electronic paper and a magnetic pattern forming apparatus in a step of placing the electronic paper on the magnetic pattern forming apparatus, according to an example embodiment of the present invention;

FIG. 5 is a conceptual diagram of the magnetic pattern forming apparatus, according to an example embodiment of the present invention;

FIG. 6 is a cross-sectional schematic view of the electronic paper and the magnetic pattern forming apparatus in a step of forming a magnetic pattern, according to an example embodiment of the present invention;

FIG. 7 is a cross-sectional schematic view of electronic paper and a magnetic pattern forming apparatus in a step of forming a magnetic pattern, according to another example embodiment of the present invention;

FIG. 8 is a flowchart illustrating a method of displaying an image on electronic paper, according to another example embodiment of the present invention;

FIG. 9 is a perspective view of electronic paper and a magnetism generating apparatus, illustrating a step of forming a magnetic pattern, according to another example embodiment of the present invention;

FIG. 10 is a cross-sectional schematic view of electronic paper, according to another example embodiment of the present invention;

FIG. 11 is a perspective view of a barrier structure, according to another example embodiment of the present invention; and

FIG. 12 is a cross-sectional schematic view of electronic paper, according to another example embodiment of the present invention.

### DETAILED DESCRIPTION

Aspects and features of the present invention and methods of accomplishing the same may be understood more readily by reference to the following detailed description of example embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will be defined by the appended claims and their equivalents. Thus, in some embodiments, well-known structures and devices are not shown in order not to obscure the description of embodiments of the invention with unnecessary detail. Like numbers refer to like elements throughout. In the drawings, the thickness of layers and regions are exaggerated for clarity.

It will be understood that when an element or layer is referred to as being “on,” “connected to,” or “coupled to” another element or layer, it may be directly on or connected/coupled to the other element or layer or intervening elements or layers may be present. When an element is referred to as being “directly on,” “directly connected to” another element or layer, there may be no intervening elements or layers present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another element. Thus, for example, a first element, a first component or a first section discussed below could be termed a second element, a second component or a second section without departing from the teachings of the present invention.

Hereinafter, example embodiments of the present invention will be described with reference to the attached drawings.

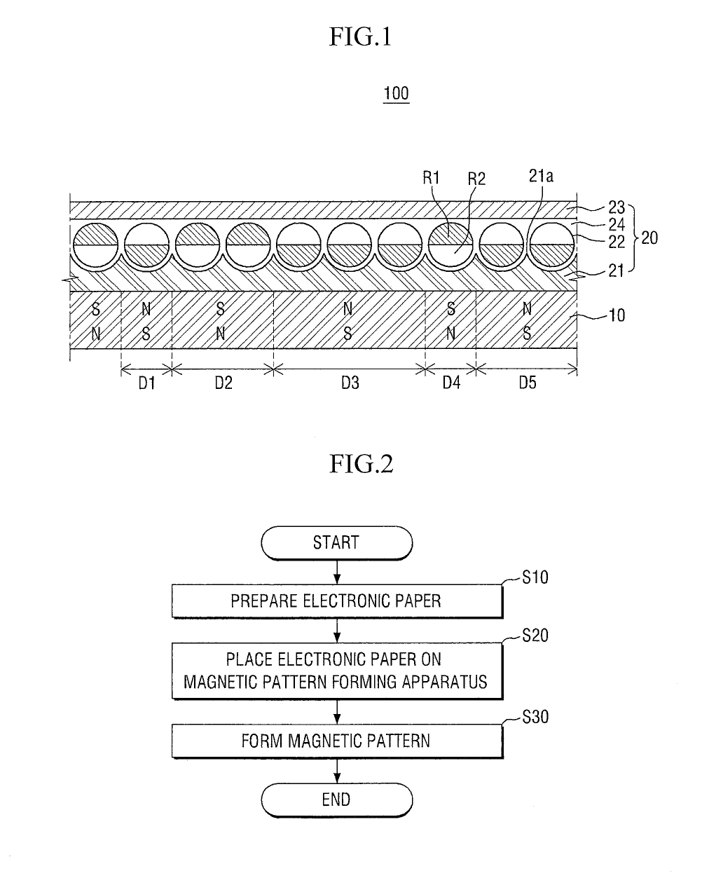

FIG. 1 is a cross-sectional view of electronic paper 100, according to an embodiment of the present invention. Referring to FIG. 1, the electronic paper 100 includes an image control layer 10 and an image display layer 20.

The image control layer 10 may contain a magnetic material. The magnetic material contained in the image control layer 10 may be, but is not limited to, iron oxide or nickel. Due to the magnetic material, the image control layer 10 may generate a magnetic field (or exert a magnetic force) in response to an external magnetic field (or a magnetic force) applied thereto and may maintain the magnetic field even after the external magnetic force is removed. When magnetic fields of different polarities are applied to different regions of the image control layer 10, the regions of the image control layer 10 may in turn generate magnetic forces of different polarities. Accordingly, a magnetic pattern may be formed in the image control layer 10. The image control layer 10 may be divided into a plurality of magnetic domains, and the magnetic domains may, for example, include first through fifth magnetic domains D1 through D5. In each of the magnetic domains, a magnetic field may be created having an opposite polarity to (e.g., in an opposite direction to) those of magnetic fields formed in adjacent magnetic domains. For example, in the second magnetic domain D2, a magnetic field may be formed such that an N pole (i.e., the north pole) is under an S pole (i.e., the south pole). However, in each of the first magnetic domain D1 and the third magnetic domain D3 adjacent to the second magnetic domain D2, a magnetic field may be generated such that the S pole is under the N pole. The first through fifth magnetic domains D1 through D5 shown in FIG. 1 are merely an example, and the width and polarity of each magnetic domain may vary. The image control layer 10 may control the motion of a plurality of image display units 22 according to a magnetic pattern, thereby controlling an image displayed on the electronic paper 100. Because the magnetic field of the image control layer 10 may be maintained even without the external magnetic field, the magnetic pattern of the image control layer 10 may also be maintained even without applying the external magnetic field. When the magnetic pattern is maintained, the orientations of the image display units 22 may also be maintained. Therefore, the electronic paper 100 may continuously maintain the displayed image without consuming power. As a result, the power consumption of the electronic paper 100 may be reduced.

The image display layer 20 may be located (or disposed) on the image control layer 10. The image display layer 20 may display an image, and the image displayed on the image display layer 20 may be controlled by a magnetic pattern formed in the image control layer 10.

The image display layer 20 may include the image display units 22. The image display units 22 have magnetic properties. Due to the magnetic properties, the orientations of the image display units 22 may be controlled according to a magnetic pattern formed in the image display layer 20, and an image may be displayed accordingly. The image display units 22 may be spherical, but are not limited thereto, such that they may easily rotate according to a change in the magnetic pattern.

A magnetic field of each of the image display units 22 may be weaker than a magnetic field of a magnetic pattern formed in the image control layer 10. When the magnetic field of each of the image display units 22 is weaker than the magnetic field of the magnetic pattern formed in the image control layer 10, the magnetic field of the magnetic pattern formed in the image control layer 10 may be greater than the magnetic forces that adjacent image display units 22 exerted on each other. Therefore, the adjacent image display units 22 may be prevented from being moved (e.g., being rotated or having its orientation altered) by the magnetic forces each exerts on the other.

Each of the image display units 22 may include a first region R1 and a second region R2. The first region R1 and the second region R2 may have different colors. For example, the first region R1 may have a black color, and the second region R2 may have a white color. However, the present invention is not limited thereto, and each of the first region R1 and the second region R2 may have one of, for example, red, green, blue, black or white colors. According to some embodiments, the colors of the first regions R1 included in the image display units 22 may not all be the same, and the colors of the second regions R2 included in the image display units 22 may not all be the same.

Different magnetic poles may be located in the first and second regions R1 and R2 of each of the image display units 22. For example, the first and second regions R1 and R2 may have magnetic poles of different polarity. In FIG. 1, the S pole is located in the first region R1, and the N pole is located in the second region R2. However, the present invention is not limited thereto, and the N pole may alternatively be located in the first region R1, and the S pole may alternatively be located in the second region R2. The orientations of the image display units 22 may be controlled according to a magnetic pattern formed in the image control layer 10. For example, because the S pole is under the N pole in the first magnetic domain D1, the image display unit 22 located on the first magnetic domain D1 may be oriented such that the first region R1 having the S pole, which is opposite to the N pole in an upper part of the first magnetic domain D1, is in a lower part of the image display unit 22. Therefore, the second region R2 may be in an upper part of the image display unit 22 located on the first magnetic domain D1, and the color of the second region R2 may be visible from outside of the electronic paper 100. As the orientations of the image control units 22 are controlled according to a magnetic pattern formed in the image control layer 10, an image to be displayed on the electronic paper 100 may be formed.

As described above, the electronic paper 100 may display a desired image by controlling the orientations of the image display units 22 having magnetic properties according to a magnetic pattern formed in the image control layer 10. Because the magnetic pattern formed in the image control layer 10 may be maintained even without external power or the exertion of magnetic force, the image display units 22 may maintain the displayed image without expending power (e.g., without power loss). Therefore, the electronic paper 100 may reduce the power consumed to display an image.

The image control layer 20 may further include a first substrate 21, a second substrate 23, and a lubricating fluid 24.

The first substrate 21 may be located on the image control layer 10 and under the image display units 22. The first substrate 21 may support the image control layer 10 and the image display units 22. The image control layer 10 may be attached to a bottom surface of the first substrate 21. According to some embodiments, the image control layer 10 may be coated on the bottom surface of the first substrate 21. The first substrate 21 may be formed of a nonmagnetic material. When the first substrate 21 is formed of a nonmagnetic material, the magnetic field of the image control layer 10 may pass through the first substrate 21 to control the orientations of the image display units 22.

The first substrate 21 may include alignment portions 21a. The alignment portions 21a may protrude upward from a top surface of the first substrate 21. Each of the alignment portions 21a may be inserted between the image display units 22 to align the image display units 22. The top surface of the first substrate 21 between the alignment portions 21a may be, but is not limited to, part of a spherical surface.

The second substrate 23 may be located on the image display units 22. The image display units 22 may be housed between the first substrate 21 and the second substrate 23. The second substrate 23 may be formed of a transparent material such that the image display units 22 are visible from outside the electronic paper 100. The second substrate 23 may be formed of a nonmagnetic material so as not to affect the motion of the image display units 22 having magnetic properties.

The lubricating fluid 24 may be located between the first substrate 21 and the second substrate 23, together with (e.g., surrounding) the image display units 22. The lubricating fluid 24 may reduce the friction between the first and second substrates 21 and 23 and the image display units 22, so that the orientations of the image display units 22 may be smoothly controlled according to a magnetic pattern of the image control layer 10. The lubricating fluid 24 may be formed of a transparent material to allow the image display units 22 to be visible from outside the electronic paper 100.

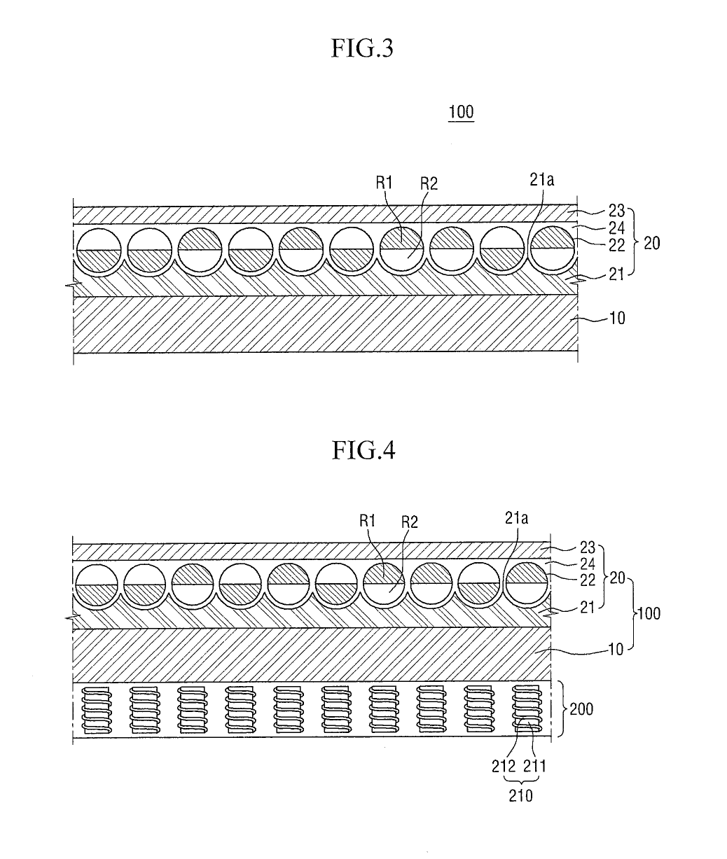

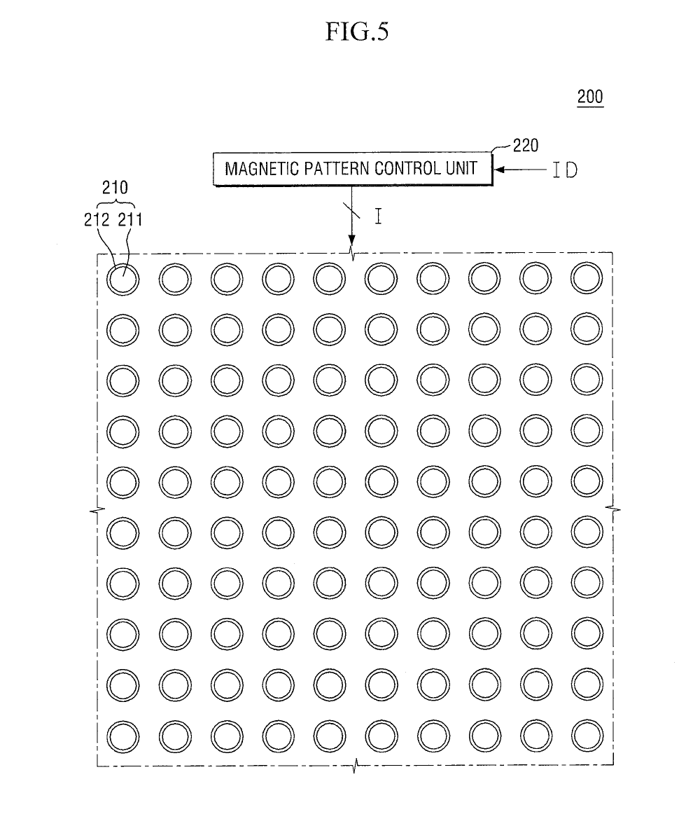

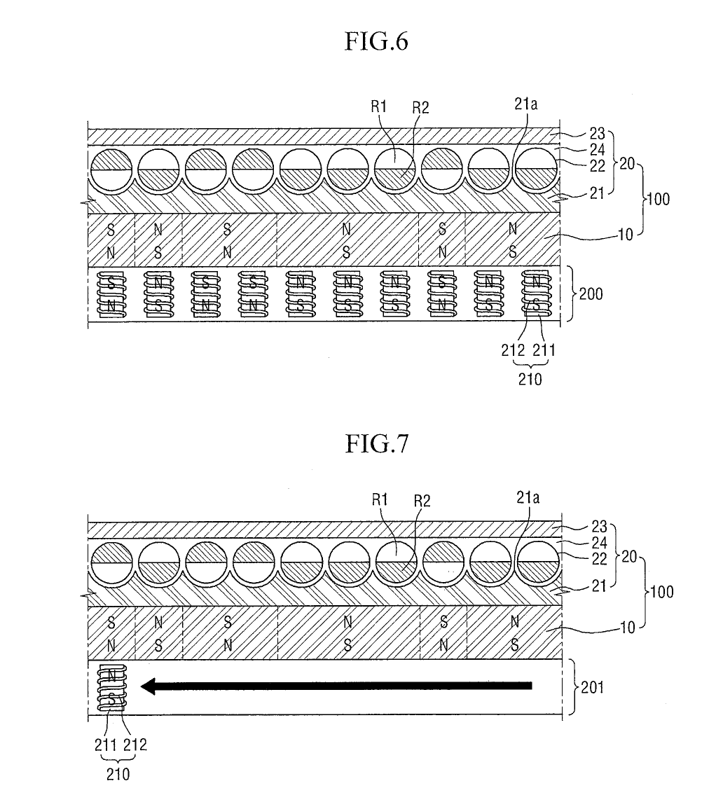

A method of displaying an image on the electronic paper 100 will now be described in greater detail with reference to FIGS. 2 through 6. FIG. 2 is a flowchart illustrating a method of displaying an image on an electronic paper, according to an embodiment of the present invention. FIG. 3 is a cross-sectional schematic view of electronic paper in one step of a process of preparing the electronic paper, according to an embodiment of the present invention. FIG. 4 is a cross-sectional view of the electronic paper and a magnetic pattern forming apparatus in a step of placing the electronic paper on the magnetic pattern forming apparatus, according to an embodiment of the present invention. FIG. 5 is a conceptual diagram of the magnetic pattern forming apparatus, according to an embodiment of the present invention. FIG. 6 is a cross-sectional schematic view of the electronic paper and the magnetic pattern forming apparatus in a step of forming a magnetic pattern, according to an embodiment of the present invention.

Referring to FIG. 2, the method of displaying an image on electronic paper 100 includes preparing the electronic paper 100 (step S10), placing the electronic paper 100 on a magnetic pattern forming apparatus 200 (step S20), and forming a magnetic pattern (step S30).

In the step S10 of preparing of the electronic paper 100, the electronic paper 100 as shown in FIG. 3 may be prepared. Here, an image control layer 10 may have no magnetic pattern formed therein, and thus image display units 22 may be oriented randomly. According to some embodiments, the image control layer 10 may have a magnetic pattern (e.g., a pre-existing magnetic pattern), and thus the image display units 22 may already be oriented according to the magnetic pattern.

In the step S20 of placing of the electronic paper 100 on the magnetic pattern forming apparatus 200, the electronic paper 100 may be placed on the magnetic pattern forming apparatus 200 as shown in FIG. 4. The magnetic pattern forming apparatus 200 may include a plurality of magnetic pattern forming units 210. Each of the magnetic pattern forming units 210 may include a core 211 containing a magnetic material and a coil 212 surrounding a circumference (e.g., a periphery) of the core 211. When an electric current flows through the coil 212, the core 211 may have a magnetic field, and a corresponding one of the magnetic pattern forming units 210 may function as an electromagnet. In FIG. 4, the magnetic pattern forming units 210 are electromagnets. However, the present invention is not limited thereto, and the magnetic pattern forming units 210 may also be permanent magnets whose rotation may be controlled. The magnetic pattern forming units 210 may be located to correspond to the image display units 22, respectively. However, the disposition of the magnetic pattern forming units 210 is not limited to this example.

The magnetic pattern forming apparatus 200 will now be described in more detail with reference to FIG. 5. Referring to FIG. 5, the magnetic pattern forming apparatus 200 may include the magnetic pattern forming units 210 and a magnetic pattern control unit 220.

The magnetic pattern forming units 210 may be arranged in a matrix form (e.g., arranged in a grid pattern). The magnetic pattern control unit 220 may control the direction of a magnetic field formed by each of the magnetic pattern forming units 210. For example, the magnetic pattern control unit 220 may control the direction of an electric current I flowing through the coil 210 and the magnitude of the electric current I, thereby controlling the positions of N and S poles of an electromagnet. The magnetic pattern control unit 220 may receive image data ID and control the direction of a magnetic field formed in each of the magnetic pattern forming units 210, such that an image corresponding to the image data ID may be displayed on the electronic paper 100.

Referring to FIG. 6, in the step S30 of forming of the magnetic pattern, the magnetic pattern forming units 210 may generate magnetic fields. In the step S30 of forming of the magnetic pattern, the magnetic pattern control unit 220 may cause an electric current to flow through the coil 212 included in each of the magnetic pattern forming units 210 and may control the direction of a magnetic field generated by each of the magnetic pattern forming units 210 by controlling the direction of the electric current 212 flowing through the coil 212.

A magnetic pattern may be formed in the image control layer 10 according to the direction of a magnetic field generated by each of the magnetic pattern forming units 210. For example, when the N pole is formed in an upper part of a magnetic pattern forming unit 210 and the S pole is formed in a lower part of the magnetic pattern forming unit 210, the S pole may be formed in a lower part of a region of the image control layer 10 located on the magnetic pattern forming unit 210, and the N pole may be formed in an upper part of the region. When the S pole is formed in the upper part of the magnetic pattern forming unit 210 and the N pole is formed in the lower part of the magnetic pattern forming unit 210, the opposite effect may occur. When a magnetic pattern is formed in the image control layer 10 according to the direction of a magnetic field generated by each of the magnetic pattern forming units 210, the orientations of the image display units 22 may be controlled according to the magnetic pattern. Accordingly, an image may be displayed on the electronic paper 100.

After the image is displayed on the electronic paper 100, the magnetic pattern forming apparatus 200 may be separated from the electronic paper 100, or the magnetic pattern forming units 210 may no longer generate magnetic fields. In either case, the magnetic pattern formed in the image control layer 10 may be maintained. Therefore, the image displayed on the electronic paper 100 may also be maintained. As such, power may be consumed to form a magnetic pattern in the image control layer 10 to display an image on the electronic paper 100. However, no power may be consumed to maintain the displayed image. Therefore, the power consumption of the electronic paper 100 may be reduced.

In the step S10 of preparing of the electronic paper 100, the electronic paper 100 may, for example, already be displaying a certain image because a magnetic pattern is already formed in the image control layer 10. Even in this example, a new magnetic pattern may be formed in the image control layer 10 in the step S30 of forming of the magnetic pattern. Accordingly, the image displayed on the electronic paper 100 may be changed.

A method of displaying an image on electronic paper according to another embodiment of the present invention will now be described with reference to FIG. 7. A flowchart of the method of displaying an image on electronic paper according to the current embodiment is substantially the same as the flowchart of FIG. 2. FIG. 7 is a cross-sectional schematic view of electronic paper and a magnetic pattern forming apparatus in a step of forming a magnetic pattern, according to another embodiment of the present invention.

Referring to FIG. 7, a magnetic pattern forming apparatus 201 may include a magnetic pattern forming unit 210, which may only cover a portion of the entire bottom surface of an image control layer 10. In FIG. 7, one magnetic pattern forming unit 210 is illustrated. However, the magnetic pattern forming apparatus 201 may also include one row of magnetic pattern forming units 210 from among the magnetic pattern forming units 210 arranged in a matrix form (e.g., arranged in a grid pattern) in FIG. 4, although only one magnetic pattern forming unit 210 is illustrated in the cross-sectional view of FIG. 7. In the step S30 of forming of the magnetic pattern, the magnetic pattern forming unit 210 may move in a horizontal direction, and the direction of a magnetic field generated by the magnetic pattern forming unit 210 may vary over time. Therefore, as the magnetic pattern forming unit 210 moves under the image control layer 10 while the direction of the magnetic field is varied, a corresponding magnetic pattern may be formed in the image control layer 10. A magnetic pattern control unit 220 may vary the direction of the magnetic field of the magnetic pattern forming unit 210 by controlling the direction of an electric current flowing through a coil 212 included in the magnetic pattern forming unit 210. Because the magnetic pattern forming apparatus 201 includes a reduced number of magnetic pattern forming units 210, the number of wirings used to connect the magnetic pattern control unit 220 and the magnetic pattern forming units 210 may be reduced.

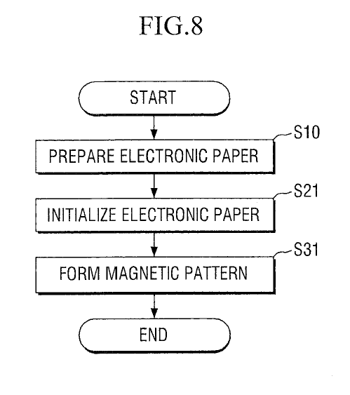

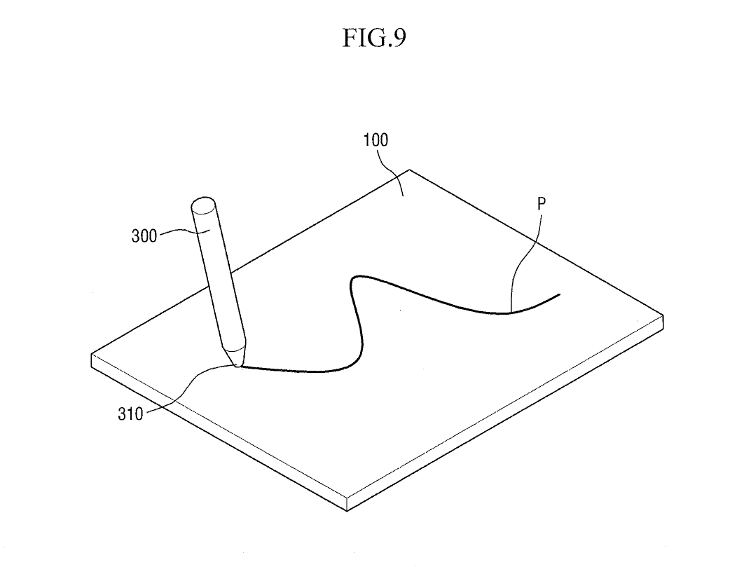

A method of displaying an image on electronic paper, according to another embodiment of the present invention, will now be described with reference to FIGS. 8 and 9. FIG. 8 is a flowchart illustrating a method of displaying an image on electronic paper, according to another embodiment of the present invention. FIG. 9 is a perspective view of electronic paper and a magnetism generating apparatus, illustrating a step of forming a magnetic pattern, according to another embodiment of the present invention.

Referring to FIG. 8, the method of displaying an image on electronic paper, according to the current embodiment, includes preparing electronic paper 100 (step S10), initializing the electronic paper 100 (step S21), and forming a magnetic pattern by moving a magnetism generating apparatus 300 (step S31). The step S10 of preparing of the electronic paper 100 is substantially the same as the preparing of the electronic paper in FIG. 2.

In the step S21 of initializing the electronic paper 100, a magnetic pattern of an image control layer 10 may be initialized. For example, in the step S21 of initializing the electronic paper 100, a magnetic pattern may be formed such that all or some regions of the image control layer 10 have the same magnetic polar direction. When a magnetic pattern is formed such that all or some regions of the image control layer 10 have the same polar direction, an image of a single color may be displayed in all or some regions of the electronic paper 100. In the regions in which the image of the single color is displayed, an image formed in the step S31 of forming the magnetic pattern by moving the magnetism generating apparatus 300 may be identified. According to some embodiments, the step S21 of initializing of the electronic paper 100 may be omitted. In this example, a pattern P of an image formed in the step S31 of forming the magnetic pattern by moving the magnetism generating apparatus 300 may be displayed to overlap an image already displayed on the electronic paper 100.

Referring to FIGS. 8 and 9, in the step S31 of forming the magnetic pattern by moving the magnetism generating apparatus 300, the magnetism generating apparatus 300 may be moved in a manner such that an end 310 of the magnetism generating apparatus 300 is in contact with or adjacent to the electronic paper 100. Accordingly, a pattern P corresponding to the movement of the magnetism generating apparatus 300 may be displayed on the electronic paper 100. An N or S pole of a magnet may be formed in the end 310 of the magnetism generating apparatus 300. Therefore, a magnetic pattern corresponding to the movement of the end 310 may be formed in the image control layer 10, and the orientations of image display units 22 may be controlled according to the magnetic pattern. As a result, the pattern P corresponding to the trajectory of the end 310 may be formed on the electronic paper 100.

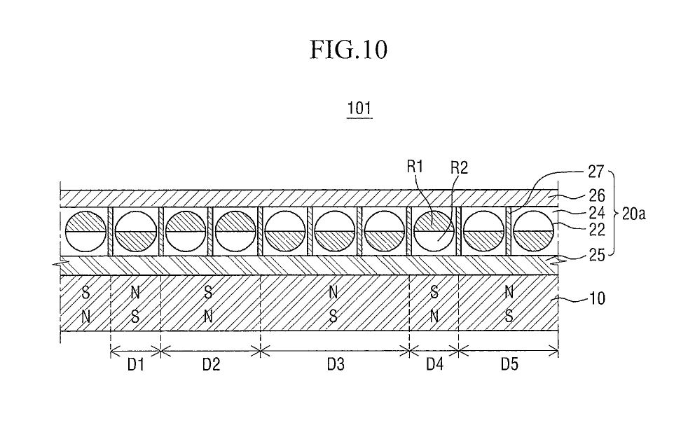

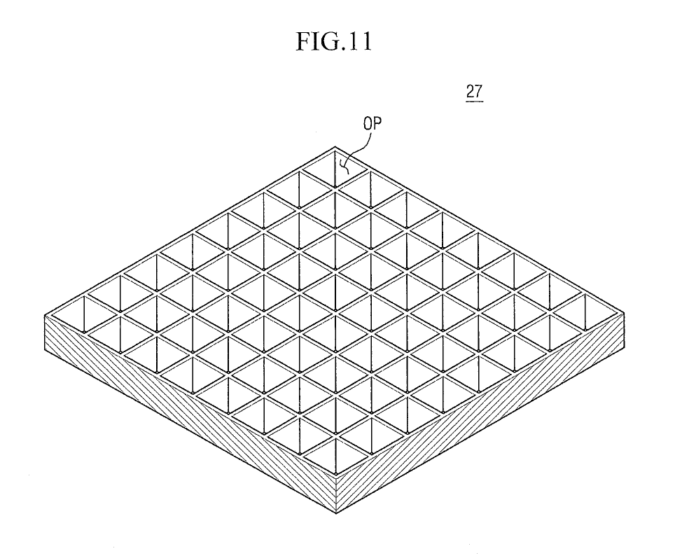

Electronic paper, according to another embodiment of the present invention, will now be described with reference to FIGS. 10 and 11. FIG. 10 is a cross-sectional schematic view of electronic paper 101, according to another embodiment of the present invention. FIG. 11 is a perspective view of a barrier structure 27, according to another embodiment of the present invention.

Referring to FIG. 10, an image display layer 20a may include a plurality of image display units 22, a lubricating fluid 24, a first substrate 25, a second substrate 26, and the barrier structure 27. The image display units 22 and the lubricating fluid 24 are substantially identical to those of FIG. 1, and thus a description thereof will not be repeated.

The first substrate 25 and the second substrate 26 may be plate-shaped (e.g., be shaped as a flat plane), and the image display units 22 may be housed between the first substrate 25 and the second substrate 26. The first substrate 25 and the second substrate 26 may be formed of a nonmagnetic material. The second substrate 26 may be formed of a transparent material.

The barrier structure 27 may be located between the first substrate 25 and the second substrate 26. The barrier structure 27 may be located between adjacent image display units 22 to separate the image display units 22 from one another.

Referring to FIG. 11, the barrier structure 27 may form a plurality of openings OP arranged in a matrix form (e.g., a grid form), and one image display unit 22 may be placed in each of the openings OP. The barrier structure 27 may be formed of a nonmagnetic material, which may not magnetically affect the motion of the image display units 27. According to some embodiments, the barrier structure 27 may be formed of a magnetic material such as iron. In these embodiments, the barrier structure 27 may block (e.g., may prevent) magnetic fields of two adjacent image display units 22 from affecting each other, thereby preventing the motion of the image display units 22.

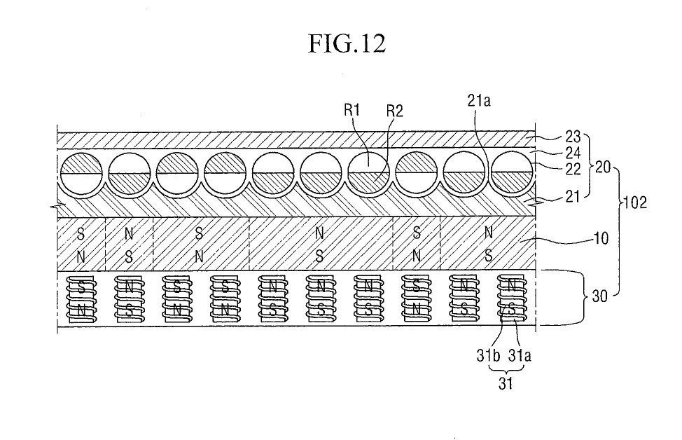

Electronic paper, according to another embodiment of the present invention, will now be described with reference to FIG. 12. FIG. 12 is a cross-sectional schematic view of electronic paper 102, according to another embodiment of the present invention.

Referring to FIG. 12, the electronic paper 102 may include an image control layer 10, an image display layer 20, and a magnetic pattern forming layer 30. The magnetic pattern forming layer 30 may include a plurality of magnetic pattern forming units 31. Each of the magnetic pattern forming units 31 may include a core 31a and a coil 31b. The magnetic pattern forming layer 30, the magnetic pattern forming units 31, the core 31a and the coil 31b may be substantially identical (e.g., identical) to the magnetic pattern forming apparatus 200, the magnetic pattern forming units 210, the core 211, and the coil 212 of FIGS. 4 and 5. Therefore, the magnetic pattern forming apparatus 200 may be integrated into the electronic paper 102 as the magnetic pattern forming layer 30.

The image control layer 10 and the image display layer 20 are substantially identical to those indicated by the same reference numerals in FIG. 1, and thus a description thereof will not be repeated.

According to some embodiments, the image display layer 20 may be replaced by the image display layer 20a of FIG. 10.

Embodiments of the present invention provide at least one of the following benefits.

For example, the power consumption of electronic paper may be reduced.

In addition, electronic paper capable of displaying an image in a new way may be provided.

However, the embodiments of the present invention are not restricted to the one set forth herein. The above and other embodiments of the present invention will become more apparent to one of ordinary skill in the art to which the present invention pertains by referencing the claims, which, together with their equivalents, define the scope of the present invention.

What is claimed is:

1. Electronic paper comprising:
an image control layer comprising a magnetic material and capable of forming a magnetic pattern therein and
an image display layer on the image control layer, the image display layer comprising a plurality of image display units having magnetic properties.

2. The electronic paper of claim 1, further comprising a magnetic pattern forming layer under the image control layer, the magnetic pattern forming layer comprising a plurality of magnetic pattern forming units, each of the magnetic pattern forming units being configured to generate a magnetic field having a direction that can be controlled.

3. The electronic paper of claim 2, wherein each of the magnetic pattern forming units comprises an electromagnet.

4. The electronic paper of claim 3, wherein the electromagnet comprises a core and a coil around the core, the electronic paper further comprising a magnetic pattern control unit configured to control the direction of an electric current flowing through the coil according to image data.

5. The electronic paper of claim 1, wherein each of the image display units comprises a first region and a second region having different colors, wherein magnetic poles located in the first region and the second region are different from each other.

6. The electronic paper of claim 5, wherein the image display units have a spherical shape.

7. The electronic paper of claim 1, wherein the image display layer comprises:
a first substrate;
a second substrate on the first substrate; and
a barrier structure between the first substrate and the second substrate and having a plurality of openings,
wherein each of the image display units is located in a corresponding one of the openings.

8. The electronic paper of claim 7, wherein the first substrate and the second substrate comprise a nonmagnetic material.

9. The electronic paper of claim 1, wherein the image display layer comprises:
a first substrate; and
a second substrate on the first substrate,
wherein the image display units are between the first substrate and the second substrate, and the first substrate comprises alignment portions protruding upward from a top surface of the first substrate, the alignment portions being located between the image display units.

10. The electronic paper of claim 9, further comprising a lubricating fluid between the first substrate and the second substrate.

11. The electronic paper of claim 1, wherein a magnetic field of the image control layer in which the magnetic pattern is formed is greater than a magnetic field of each of the image display units.

12. A method of displaying an image on an electronic paper, the method comprising:
preparing the electronic paper comprising an image control layer comprising a magnetic material, and an image display layer comprising a plurality of image display units having magnetic properties, the image display layer being on the image control layer;
placing the electronic paper on a magnetic pattern forming apparatus comprising a plurality of magnetic pattern forming units, each of the magnetic pattern forming units being configured to generate a magnetic field having a direction that can be controlled; and
forming a magnetic pattern in the image control layer by controlling the direction of the magnetic field of each of the magnetic pattern forming units.

13. The method of claim 12, wherein each of the magnetic pattern forming units comprises an electromagnet comprising a core and a coil around the core, and wherein the controlling of the direction of the magnetic field of each of the magnetic pattern forming units comprises controlling the direction of an electric current flowing through the coil of each of the magnetic pattern forming units.

14. The method of claim 12, wherein each of the image display units comprises a first region and a second region having different colors, wherein magnetic poles located in the first region and the second region are different from each other.

15. The method of claim 12, wherein the image display layer comprises:
a first substrate;
a second substrate on the first substrate; and
a barrier structure between the first substrate and the second substrate and having a plurality of openings,
wherein each of the image display units is located in a corresponding one of the openings.

16. The method of claim 12, wherein the forming of the magnetic pattern comprises moving the magnetic pattern forming units while varying the direction of the magnetic field of each of the magnetic pattern forming units.

17. The method of claim 12, wherein the image display layer comprises:
a first substrate; and
a second substrate on the first substrate,
wherein the image display units are between the first substrate and the second substrate, and the first substrate comprises alignment portions protruding upward from a top surface of the first substrate, the alignment portions being located between the image display units.

18. A method of displaying an image on an electronic paper, the method comprising:
preparing the electronic paper comprising an image control layer comprising a magnetic material, and an image display layer, comprising a plurality of image display units having magnetic properties, the image display layer being on the image control layer; and
forming a magnetic pattern in the image control layer by moving a magnetism generating apparatus having a pole of a magnet disposed at an end thereof on the electronic paper.

19. The method of claim 12, further comprising initializing the electronic paper by forming a magnetic pattern in the image control layer such that magnetic fields of at least some regions of the image control layer have the same direction.

20. The method of claim 12, wherein the image display layer comprises:
a first substrate; and
a second substrate on the first substrate,
wherein the image display units are between the first substrate and the second substrate, and the first substrate comprises alignment portions protruding upward from a top surface of the first substrate, the alignment portions being located between the image display units.
